(19) United States
(12) Patent Application Publication
(10) Pub. No.: US 2012/0275276 A1
(43) Pub. Date: Nov. 1, 2012

(54) ELECTRONIC TIMEPIECE

(76) Inventors: Hiroshi SHIMIZU, Chiba-shi (JP); Kenji Ogasawara, Chiba-shi (JP); Kazumi Sakumoto, Chiba-shi (JP); Akira Takakura, Chiba-shi (JP); Keishi Honmura, Chiba-shi (JP); Saburo Manaka, Chiba-shi (JP); Kosuke Yamamoto, Chiba-shi (JP)

(21) Appl. No.: 13/439,965

(22) Filed: Apr. 5, 2012

(30) Foreign Application Priority Data
Apr. 29, 2011 (JP) 2011-102539
Feb. 28, 2012 (JP) 2012-040952

(51) Int. Cl. G04F 10/00

(52) U.S. Cl. 368/107

(57) ABSTRACT

A power generation unit generates electric power depending on light to be irradiated to a light receiving surface. An electricity storage unit stores the electric power generated by the power generation unit and outputs the stored electric power. A voltage detection unit detects a voltage of the electric power that is output from the electricity storage unit. A processing unit performs time measurement. A chronograph indicator points a time counted by the processing unit and is fixed by a mechanism while the time measurement is stopped. A second driving circuit drives the chronograph indicator by the use of the electric power that is output from the electricity storage unit. The processing unit drives the second driving circuit when the voltage of the electric power which is output from the electricity storage unit is equal to or greater than a predetermined threshold value.

### BACKGROUND OF THE INVENTION

1. Field of the Invention

The present invention relates to an electronic timepiece.

2. Background Art

In an electronic timepiece equipped with a power generation unit such as a solar cell and an electricity storage unit (a secondary battery) which stores electric power generated by the power generation unit, since the charging voltage of the power generation unit may be greater than the upper limit voltage, an overcharging prevention unit (an electric current bypass circuit) is included which limits the voltage to be applied to the electricity storage unit as an overcharge protection unit (for example, see JP-A-61-259192 and JP-A-62-123387).

FIG. 11 is a block diagram that shows a configuration of a power source unit including the overcharging prevention unit known in the related art. In a shown example, a power source unit 100 includes a power generation unit 101, a reverse current prevention unit 102, an electricity storage unit 103, and an overcharging prevention unit 104. The power generation unit 101 is a solar cell which includes a light receiving surface for receiving the light, and generates the electric power depending on the received (irradiated) light. The reverse current prevention unit 102 controls the electric current so as to flow only in a direction from the power generation unit 101 to the electricity storage unit 103. That is, the reverse current prevention unit 102 prevents the electric current from flowing from the electricity storage unit 103 to the power generation unit 101. The electricity storage unit 103 is a secondary battery and stores the electric power generated by the power generation unit 101.

The overcharging prevention unit 104 includes a voltage detection unit 105 and an electric current bypass unit 106. When the charging voltage of the electricity storage unit 103 is greater than the upper limit voltage, the overcharging prevention unit 104 discharges the electric power generated by the power generation unit 101 to the outside of the power source unit 100, so that the electric power does not flow through the electricity storage unit 103. Specifically, the voltage detection unit 105 detects a voltage value of the electricity storage unit 103, and inputs the detected voltage value of the electricity storage unit 103 to the electric current bypass unit 106. When the voltage generated by the power generation unit 101 is greater than the upper limit voltage of the charging voltage of the electricity storage unit 103, based on the input voltage value of the electricity storage unit 103, the electric current bypass unit 106 discharges the electric power generated by the power generation unit 101 to the outside of the power source unit 100.

In order to secure the electric current capacity required for limiting the output characteristics (the power generation voltage) of the power generation unit 101, a transistor used in the overcharging prevention unit 104 generally requires semiconductor area of a certain size. For that reason, deleting the semiconductor area of the transistor used in the overcharging prevention unit 104 has the effect of contributing to a decrease in size and cost of the overcharging prevention unit 104 (the electric current bypass circuit).

However, the electronic timepiece with the charging device described in JP-A-61-259192 forcibly increases the electric current consumption using the through-current by concurrently turning ON a Pch transistor and an Nch transistor of a motor driving circuit in an overcharged state. For that reason, in the type described in JP-A-61-259192, it is very difficult to control the amount of electric current due to the through-current when an overcharging prevention operation is operated, and there is a risk of degrading the performance of the electricity storage unit due to the flow of the large electric current exceeding the limit. Furthermore, the electronic timepiece with the charging device described in JP-A-62-123387 forcibly increases the electric current consumption by unconditionally generating a correction pulse when handling a needle in the overcharged state. For that reason, since the method described in JP-A-62-123387 is a method which is able to be operated only during driving of the motor, for example, there is a problem in that, even when the overcharged state is generated while the motion driving is stopped by pulling the crown, it is impossible to activate the overcharge protection operation.

### SUMMARY OF THE INVENTION

It is an aspect of the present application to provide an electronic timepiece which is able to prevent overcharging of the electricity storage unit without degrading the performance of the electricity storage unit, even in a case where the motion is stopped.

According to the present application, there is provided an electronic timepiece which is a chronograph including a reset-to-zero structure using a mechanism, and the electronic timepiece includes a power generation unit which generates electric power depending on light irradiated to a light receiving surface, an electricity storage unit which stores the electric power generated by the power generation unit and outputs the stored electric power, a voltage detection unit which detects the voltage of the electric power that is output from the electricity storage unit, a time measurement unit which performs the time measurement, a chronograph indicator which indicates the time counted by the time measurement unit and is fixed by the mechanism while the time measurement is stopped, a driving circuit which drives the chronograph indicator using the electric power that is output from the electricity storage unit, and a control unit which drives the driving circuit when the voltage of the electric power which is output from the electricity storage unit is equal to or greater than a predetermined threshold value.

Furthermore, in the electronic timepiece of the present application, the driving circuit may output a first driving pulse using the electric power which is output from the electricity storage unit and drive the chronograph indicator, and when the voltage of the electric power which is output from the electricity storage unit is equal to or greater than a predetermined threshold value while the time measurement is stopped, the control unit may control the driving circuit to output a second driving pulse having a driving energy greater than that of the first driving pulse.

Furthermore, in the electronic timepiece of the present application, the time measurement unit may perform the time measurement using a counter which adds values for each fixed time, the driving circuit may drive the chronograph indicator whenever the counter value increases by a fixed value, and the control unit may operate the counter to drive the driving circuit, when the voltage of the electric power which is output from the electricity storage unit is equal to or greater than a predetermined threshold value.

Furthermore, in the electronic timepiece of the present application, the time measurement unit may start the time measurement after resetting the counter value in a case of starting the time measurement when the counter is operated.

Furthermore, the electronic timepiece of the present application may further include a memory unit which stores a value used for the time measurement unit, wherein the time measurement unit may store the counter value in the memory unit when temporarily stopping the time measurement, and may restart the time measurement by the use of the counter value stored in the memory unit when restarting the temporarily stopped time measurement.

According to the present application, the power generation unit generates the electric power depending on the light irradiated to the light receiving surface. Furthermore, the electricity storage unit stores the electric power generated by the power generation unit and outputs the stored electric power. Furthermore, the voltage detection unit detects the voltage of the electric power which is output from the electricity storage unit. Furthermore, the time measurement unit performs the time measurement. Furthermore, the chronograph indicator indicates the time counted by the time measurement unit and is fixed by the mechanism while the time measurement is stopped. Furthermore, the driving circuit drives the chronograph indicator using the electric power which is output from the electricity storage unit. Furthermore, the control unit drives the driving circuit when the voltage of the electric power which is output from the electricity storage unit is equal to or greater than a predetermined threshold value.

As a result, when the output voltage of the electricity storage unit is equal to or greater than a predetermined threshold value, since the driving circuit is driven by the use of the electric power which is output from the electricity storage unit, the electric power stored in the electricity storage unit can be consumed. Thus, even when the needle is not handled, overcharging of the electricity storage unit can be prevented without degrading the performance of the electricity storage unit.

### BRIEF DESCRIPTION OF THE DRAWINGS

FIG. 1 is a block diagram that shows a configuration of a control system of an electronic timepiece in a first embodiment of the present invention.

FIG. 2 is a flowchart that shows an operation sequence of the electronic timepiece in the first embodiment of the present invention.

FIG. 3 is a flowchart that shows a processing sequence of a time motor drive processing in the first embodiment of the present invention.

FIG. 4 is a flowchart that shows a processing sequence of a chrono motor drive processing in the first embodiment of the present invention.

FIG. 5 is a flowchart that shows a processing sequence of a switch A processing in the first embodiment of the present invention.

FIG. 6 is a flowchart that shows a processing sequence of a switch B processing in the first embodiment of the present invention.

FIG. 7 is a flowchart that shows a processing sequence of a voltage detection processing in the first embodiment of the present invention.

FIG. 8 is a flowchart that shows a processing sequence of a time motion timing generation processing in the first embodiment of the present invention.

FIG. 9 is a flowchart that shows a processing sequence of a chrono motion timing generation processing in the first embodiment of the present invention.

FIG. 10 is a flowchart that shows a processing sequence of a chrono motor drive processing in a second embodiment of the present invention.

FIG. 11 is a block diagram that shows a configuration of a power source unit including an overcharging prevention unit known in the related art.

### DETAILED DESCRIPTION OF THE INVENTION

### First Embodiment

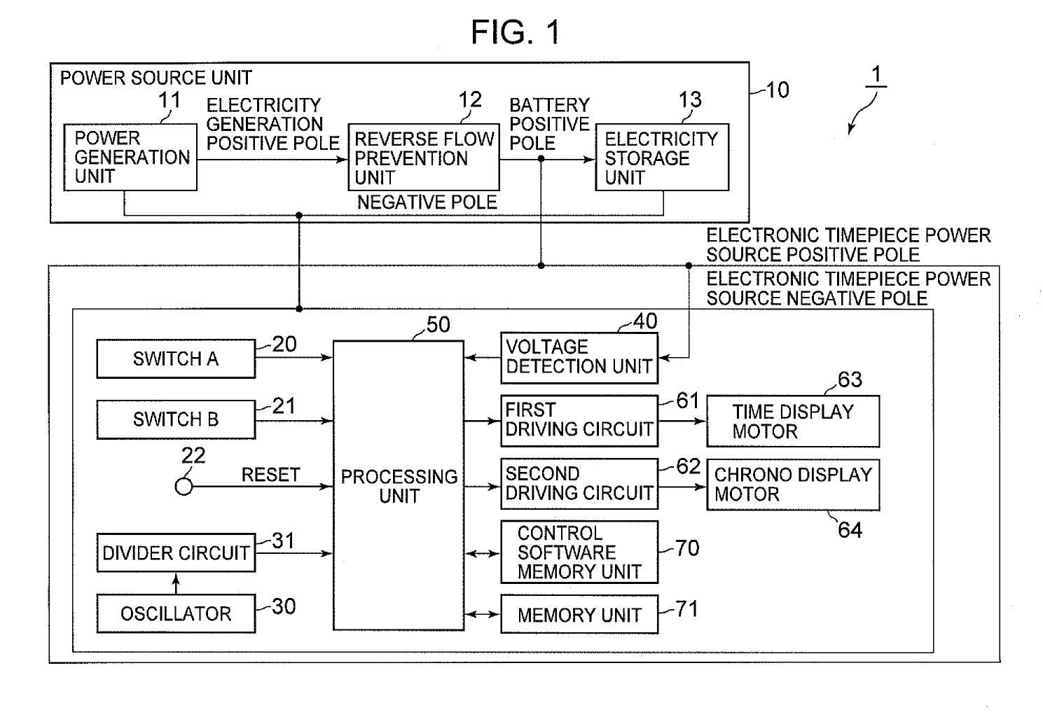

Hereinafter, a first embodiment of the present invention will be described with reference to the drawings. FIG. 1 is a block diagram that shows a configuration of a control system of an electronic timepiece 1 in the present embodiment. In addition, the electronic timepiece 1 in the present embodiment is a chronograph which includes a chronograph minute hand, a chronograph second hand, and a chronograph 1/10 second hand (not shown) as chronograph indicators. The chronograph minute hand, the chronograph second hand, and the chronograph 1/10 second hand are needles which realize a stopwatch function for measuring the time (an elapsed time). Furthermore, a reset-to-zero structure of the chronograph of the electronic timepiece 1 is depends on a mechanism. When the time measurement operation by the chronograph is not performed, the chronograph minute hand, the chronograph second hand, and the chronograph 1/10 second hand are mechanically fixed. In addition, naturally, in a case of performing the time measurement operation by the chronograph, the fixing of the chronograph minute hand, the chronograph second hand and the chronograph 1/10 second hand is released.

In the shown example, the control system of the electronic timepiece 1 includes a power source unit 10, a switch A20, a switch B21, a reset button 22, an oscillator 30, a divider circuit 31, a voltage detection unit 40, a processing unit 50 (a time measurement unit and a control unit), a first driving circuit 61, a second driving circuit 62 (a driving circuit), a time display motor 63, a chrono display motor 64, a control software memory unit 70, and a memory unit 71.

The power source unit 10 includes a power generation unit 11, a reverse current prevention unit 12, and an electricity storage unit 13, and supplies the electric power to each unit included in the electronic timepiece 1. The power generation unit 11 is a solar cell including a light receiving surface which receives the light, and generates the electric power depending on the received (irradiated) light. The reverse current prevention unit 12 controls the electric current so as to flow only in a direction from the power generation unit 11 to the electricity storage unit 13. That is, the reverse current prevention unit 12 prevents the electric current from flowing from the electricity storage unit 13 to the power generation unit 11. The electricity storage unit 13 is a secondary battery, stores the electric power generated by the power generation unit 11, and outputs the electronic power to the respective units included in the electronic timepiece 1.

The switch A20 accepts a start instruction and a stop instruction of the time measurement operation by the chronograph from a user. Specifically, when the switch A20 is pressed in a case of performing the time measurement operation by the chronograph, the electronic timepiece 1 temporarily stops the time measurement operation by the chronograph. At this time, the electronic timepiece 1 mechanically fixes the chronograph minute hand, the chronograph second hand, and the chronograph 1/10 second hand by the mechanism. Furthermore, when the switch A20 is pressed when not the time measurement operation by the chronograph, the electronic timepiece 1 starts the time measurement operation by the chronograph. At this time, the electronic timepiece 1 releases the fixing of the chronograph minute hand, the chronograph second hand and the chronograph 1/10 second hand by the mechanism.

The switch B21 accepts a reset instruction (a reset-to-zero instruction) of the time measurement operation by the chronograph from a user. Furthermore, when the switch B21 is pressed, the electronic timepiece 1 mechanically drives and fixes the chronograph minute hand, the chronograph second hand and the chronograph 1/10 second hand so that the position pointed by the chronograph minute hand, the chronograph second hand and the chronograph 1/10 second hand is “0”. The reset button 22 accepts the reset instruction which initializes the processing unit 50 from a user, and inputs a reset signal, which performs the initialization of the processing unit 50, to the processing unit 50.

The oscillator 30 periodically outputs consecutive standard clock signals at regular intervals. The divider circuit 31 divides the standard clock signal which is input from the oscillator 30, and outputs the same to the processing unit 50. The voltage detection unit 40 detects the voltage value (the output voltage value), which is output from the electricity storage unit 13, and outputs the detected voltage value to the processing unit 50.

The processing unit 50 reads the program memorized in a software control memory unit 70, executes the read program, and performs the control and the time measurement of the respective units included in the electronic timepiece 1. For example, the processing unit 50 adds the values of the time counter based on the standard clock signal which is input from the divider circuit 31. Moreover, the processing unit 50 determines the timing which drives an hour hand, a minute hand and a second hand indicating the time based on the time counter value, and drives the first driving circuit 61. Furthermore, the processing unit 50 adds the values of the chrono counter (the counter) based on the standard clock signal which is input from the divider circuit 31. Moreover, the processing unit 50 determines the timing which drives the chronograph minute hand, the chronograph second hand, and the chronograph 1/10 second hand, based on the chrono counter value, and drives the second driving circuit 62. That is, the processing unit 50 performs the time measurement using the chrono counter. Furthermore, the processing unit 50 determines whether or not the electricity storage unit 13 is in the overcharged state based on the output voltage value of the electricity storage unit 13 detected by the voltage detection unit 40. When the electricity storage unit 13 is in the overcharged state, the processing unit 50 drives the second driving circuit 62, and prevents overcharging of the electricity storage unit 13 by consuming the electric power stored in the electricity storage unit 13. In addition, the detailed operation sequence of the processing unit 50 will be described later.

The first driving circuit 61 outputs a main driving pulse and a correction driving pulse based on the control of the processing unit 50, and drives the time display motor 63. The second driving circuit 62 outputs the main driving pulse and the correction driving pulse based on the control of the processing unit 50, and drives the chrono display motor 64. The time display motor 63 drives the needle indicating the time, based on the main driving pulse and the correction driving pulse that are output from the first driving circuit 61. The chrono display motor 64 drives the chronograph indicators (the chronograph minute hand, the chronograph second hand, and the chronograph 1/10 second hand) based on the main driving pulse and the correction driving pulse that are output from the second driving circuit 62. The control software memory unit 70 memorizes the program that is executed by the processing unit 50.

The memory unit 71 stores the data or the like which is used for each unit of the electronic timepiece 1. For example, the memory unit 71 memorizes a “time motion timing flag” indicating the timing which moves the needle indicating the time. In the time motion timing flag, either of two values of “set” and “reset” is set. The time motion timing flag “set” indicates that the time motion timing, which is timing for driving the needle indicating the time, is generated. The time motion timing flag “reset” indicates that the time motion timing is not generated.

Furthermore, the memory unit 71 memorizes a “chrono motion timing flag” indicating the timing which moves the chronograph indicator. In the chrono motion timing flag, any one value of two values of the “set” and the “reset” is set. The chrono motion timing flag “set” indicates that the chrono motion timing, which is timing for driving chronograph indicator, is generated. The chrono motion timing flag “reset” indicates that the chrono motion timing is not generated.

Furthermore, the memory unit 71 memorizes a “chrono state flag” which indicates the operation state of the chronograph. In the chrono state flag, any one value of three values of a “chrono reset state”, a “chrono stop state” and a “chrono measurement state” is set. The chrono state flag “chrono reset state” indicates that the chronograph indicator is stopped at a position of “0”. The chrono state flag “chrono stop state” indicates that the chronograph indicator is stopped in a position other than “0”, that is, the time measurement operation by the chronograph is temporarily stopped. The chrono state flag “chrono measurement state” indicates that the time is measured (counted).

Furthermore, the memory unit 71 memorizes a “charging state flag” which indicates a charging state of the electricity storage unit 13. In the charging state flag, any one value of two values of an “overcharged state” and a “normal state” is set. The charging state flag “overcharged state” indicates that the electricity storage unit 13 is in the overcharged state. The charging state flag “normal state” indicates that the electricity storage unit 13 is not the overcharged state (is the normal state).

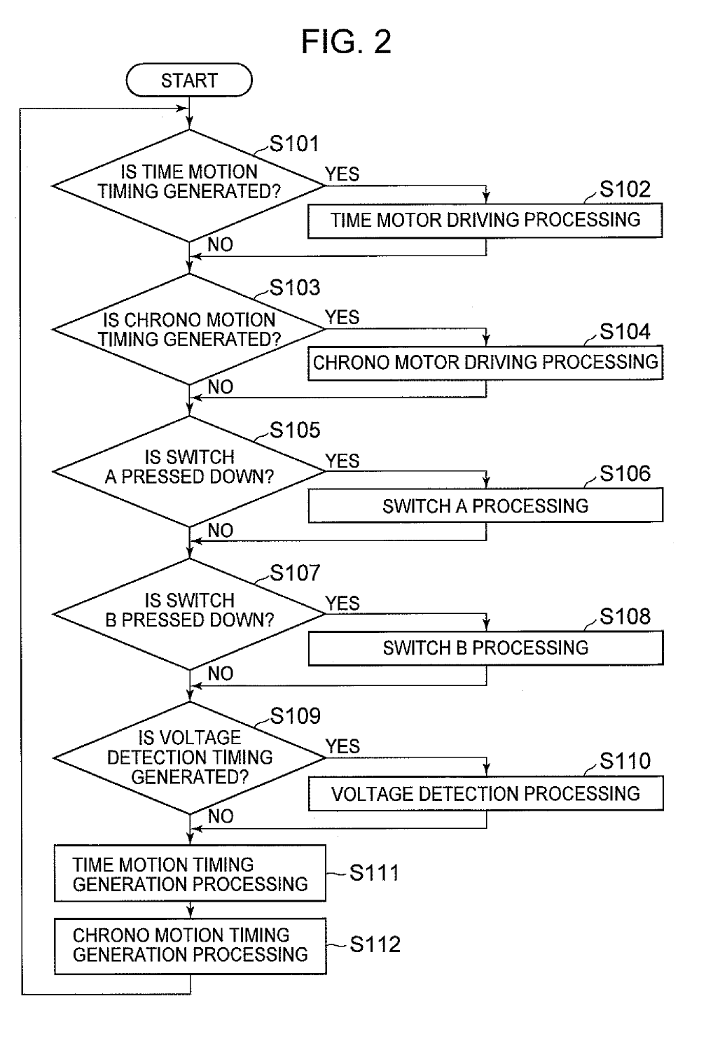

Next, an operation sequence of the electronic timepiece 1 will be described. FIG. 2 is a flowchart that shows an operation sequence of the electronic timepiece 1 in the present embodiment.

(Step S101) The processing unit 50 determines whether the value of the time motion timing flag, which indicates the timing of moving the needle indicating the time, is the “set” or the “reset”. When the processing unit 50 determines that the value of the time motion timing flag is the “set” (the time motion timing is generated), the process proceeds to the processing of step S102. When the processing unit 50 determines that the value of the time motion timing flag is the “reset” (the time motion timing is not generated), the process proceeds to the processing of step S103.

(Step S102) The processing unit 50 executes the time motor driving processing. After that, the process proceeds to the processing of step S103. In addition, a processing sequence of the time motor driving processing will be described later.

(Step S103) The processing unit 50 determines whether the value of the chrono motion timing flag, which indicates the timing of moving the chronograph indicator, is the “set” or the “reset”. When the processing unit 50 determines that the value of the chrono motion timing flag is the “set” (the chrono motion timing is generated), the process proceeds to the processing of step S104. When the processing unit 50 determines that the value of the chrono motion timing flag is the “reset” (the chrono motion timing is not generated), the process proceeds to the processing of step S105.

(Step S104) The processing unit 50 executes the chrono motor driving processing. After that, the process proceeds to the processing of step S105. In addition, a processing sequence of the chrono motor driving processing will be described later.

(Step S105) The processing unit 50 determines whether or not the switch A20 is pressed down. When the processing unit 50 determines that the switch A20 is pressed down (depressing of the switch A20 occurs), the process proceeds to the processing of step S106. When the processing unit 50 determines that the switch A20 is not pressed down (depressing of the switch A20 is not generated), the process proceeds to the processing of step S107.

(Step S106) The processing unit 50 executes the switch A processing. After that, the process proceeds to the processing of step S107. In addition, a processing sequence of the switch A processing will be described later.

(Step S107) The processing unit 50 determines whether or not the switch B21 is pressed down. When the processing unit 50 determines that the switch B21 is pressed down (depressing of the switch B21 occurs), the process proceeds to the processing of step S108. When the processing unit 50 determines that the switch B21 is not pressed down (depressing of the switch B21 does not occur), the process proceeds to the processing of step S109.

(Step S108) The processing unit 50 executes the switch B processing. After that, the process proceeds to the processing of step S109. In addition, a processing sequence of the switch B processing will be described later.

(Step S109) The processing unit 50 determines whether there is the timing for detecting the output voltage of the electricity storage unit 13. When the processing unit 50 determines that there is the timing for detecting the output voltage of the electricity storage unit 13 (the voltage detection timing is generated), the process proceeds to the processing of step S110. When the processing unit 50 determines that there is no timing for detecting the output voltage of the electricity storage unit 13 (the voltage detection timing is not generated), the process proceeds to the processing of step S111. For example, when detecting the output voltage of the electricity storage unit 13 at intervals of 10 seconds, the process proceeds to the processing of step S110 for each 10 second and the voltage detection processing is executed. In addition, the timing for detecting the output voltage of the electricity storage unit 13 can be set to an arbitrary interval without being limited to the intervals of 10 seconds.

(Step S110) The processing unit 50 executes the voltage detection processing. After that, the process proceeds to the processing of step S111. In addition, a processing sequence of the voltage detection processing will be described later.

(Step S111) The processing unit 50 executes the time motion timing generation processing. After that, the process proceeds to the processing of step S112. In addition, a processing sequence of the time motion timing generation processing will be described later.

(Step S112) The processing unit 50 executes a chrono motion timing generation processing. After that, the process returns to the processing of step S101. In addition, a processing sequence of the chrono motion timing generation processing will be described later.

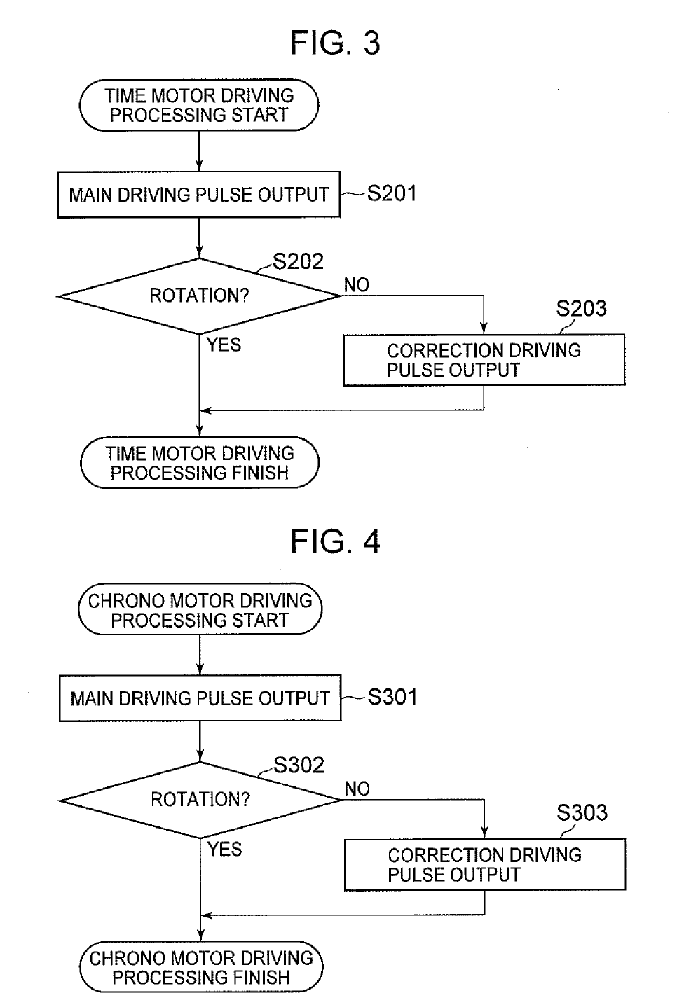

Next, the processing sequence of the time motor driving processing will be described. FIG. 3 is a flowchart that shows the processing sequence of the time motor driving processing in the present embodiment.

(Step S201) The processing unit 50 controls the first driving circuit 61 to output the main driving pulse to the time display motor 63. The time display motor 63 is rotated based on the main driving pulse, and drives the needle indicating the time. In addition, in some cases, depending on the environmental conditions in which the time display motor 63 is placed, the time display motor 63 cannot be rotated in the main driving pulse, and the needle indicating the time cannot be driven. After that, the process proceeds to the processing of step S202.

(Step S202) The processing unit 50 determines whether or not the time display motor 62 is rotated in the processing of step S201. When the processing unit 50 determines that the time display motor 63 is rotated in the processing of step S201, the time motor drive processing is finished. When the processing unit 50 determines that the time display motor 63 is not rotated in the processing of step S201, the process proceeds to the processing of step S203.

(Step S203) The processing unit 50 controls the first driving circuit 61 to output the correction driving pulse having driving energy higher than that of the main driving pulse to the time display motor 63. The time display motor 63 is rotated based on the correction driving pulse, and drives the needle indicating the time. After that, the time motor drive processing is finished.

By executing the processings from step S201 to step S203 mentioned above, the electronic timepiece 1 can drive the needle indicating the time.

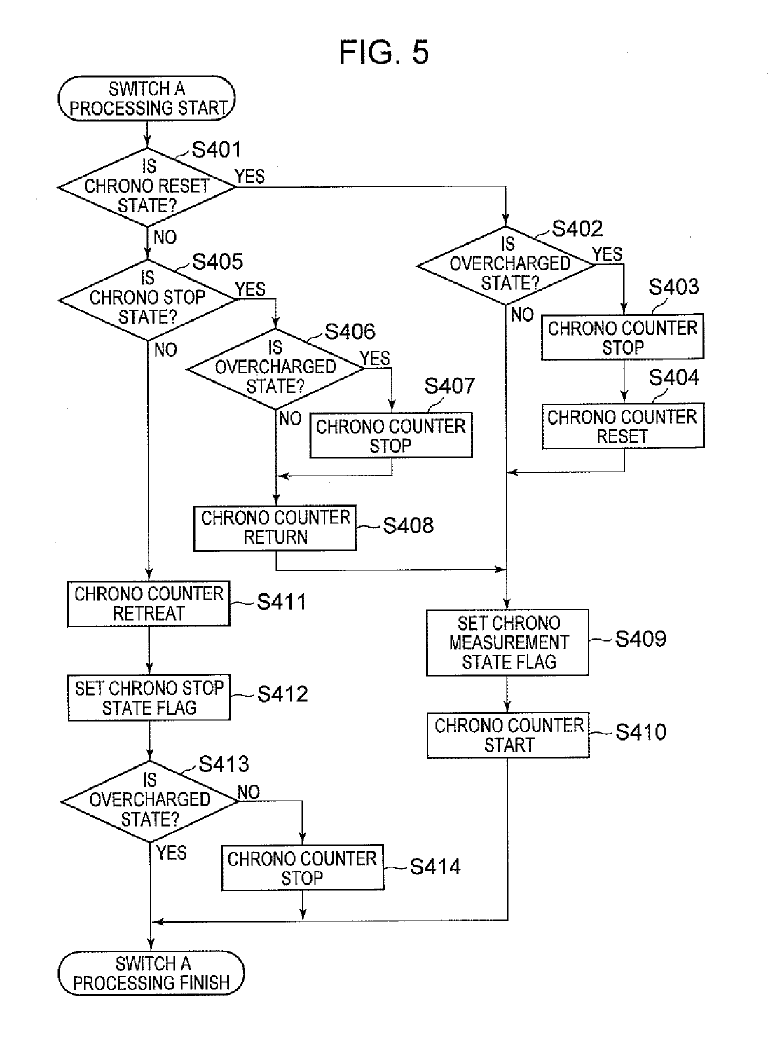

Next, the processing sequence of the chrono motor drive processing will be described. FIG. 4 is a flowchart that shows the processing sequence of the chrono motor drive processing in the present embodiment.

(Step S301) The processing unit 50 controls the second driving circuit 62 to output the main driving pulse to the chrono display motor 64. The chrono display motor 64 is rotated based on the main driving pulse, and drives the chronograph indicator. In addition, in some cases, depending on the environmental conditions in which the chrono display motor 64 is placed, the chrono display motor 64 cannot be rotated in the main driving pulse, and the chrono needle cannot be driven. After that, the process proceeds to the processing of step S302.

(Step S302) The processing unit 50 determines whether or not the chrono display motor 64 is rotated in the processing of step S301. When the processing unit 50 determines that the chrono display motor 64 is rotated in the processing of step S301, the chrono motor drive processing is finished. When the processing unit 50 determines that the chrono display motor 64 is not rotated in the processing of step S301, the process proceeds to the processing of step S303.

(Step S303) The processing unit 50 controls the second driving circuit 62 to output the correction driving pulse having driving energy higher than that of the main driving pulse to the chrono display motor 64. The chrono display motor 64 is rotated based on the correction driving pulse, and drives the chronograph indicator. After that, the chrono motor drive processing is finished.

By executing the processings from step S301 to step S303 mentioned above, the electronic timepiece 1 can drive the chronograph indicator.

Next, the processing sequence of the switch A processing will be described. FIG. 5 is a flowchart that shows the processing sequence of the switch A processing in the present embodiment.

(Step S401) The processing unit 50 determines whether the value of the chrono state flag indicating the operation state of the chronograph is the “chrono reset state” indicating that the chronograph indicator is stopped at the position of “0”. When the processing unit 50 determines that the value of the chrono state flag is the “chrono reset state”, the process proceeds to the processing of step S402, and in other cases, the process proceeds to the processing of step S405.

(Step S402) The processing unit 50 determines whether or not the value of the charging state flag indicating the charging state of the storage unit 13 is the “overcharged state” indicating the overcharged state. When the processing unit 50 determines that the value of the charging state flag is the “overcharged state”, the process proceeds to the processing of step S403, and in other cases, the process proceeds to processing of step S409.

(Step S403) The processing unit 50 stops the chrono counter. After that, the process proceeds to the processing of step S404.

(Step S404) The processing unit 50 sets the chrono counter value to “0” (reset). After that, the process proceeds to step S409.

(Step S405) The processing unit 50 determines whether or not the value of the chrono state flag indicating the operation state of the chronograph is the “chrono stop state” indicating that the chronograph indicator is stopped at the position other than “0”. When the processing unit 50 determines that the value of the chrono state flag is the “chrono stop state”, the process proceeds to the processing of step S406, and in other cases, the process proceeds to the processing of step S411.

(Step S406) The processing unit 50 determines whether or not the value of the charging state flag indicating the charging state of the electricity storage unit 13 is the “overcharged state” indicating the overcharged state. When the processing unit 50 determines that the value of the charging state flag is the “overcharged state”, the process proceeds to the processing of step S407, and in other cases, the process proceeds to the processing of step S408.

(Step S407) The processing unit 50 stops the chrono counter. After that, the process proceeds to the processing of step S408.

(Step S408) The processing unit 50 replaces the chrono counter value with a temporary memory counter value memorized in the memory unit 71 (returns the chrono counter value). After that, the process proceeds to the processing of step S409.

(Step S409) The processing unit 50 sets the value of the chrono state flag indicating the operation state of the chronograph to the “chrono measurement state” indicating the state of measuring the time. After that, the process proceeds to the processing of step S410.

(Step S410) The processing unit 50 starts the chrono counter. After that, the switch A processing is finished.

(Step S411) The processing unit 50 memorizes the chrono counter value as the temporary memory counter value in the memory unit 71. After that, the process proceeds to the processing of step S412.

(Step S412) The processing unit 50 sets the value of the chrono state flag indicating the operation state of the chronograph to the “chrono stop state” indicating that the chronograph indicator is stopped at the position other than “0”. After that, the process proceeds to the processing of step S413.

(Step S413) The processing unit 50 determines whether or not the value of the charging state flag indicating the charging state of the electricity storage unit 13 is the “overcharged state” indicating the overcharged state. When the processing unit 50 determines that the value of the charging state flag is the “overcharged state”, the switch A processing is finished, and in other cases, the process proceeds to the processing of step S414.

(Step S414) The processing unit 50 stops the chrono counter. After that, the switch A processing is finished.

By executing the processings from step S401 to step S414 mentioned above, the electronic timepiece 1 is able to perform the starting and the temporary stop of the time measurement operation using the chronograph.

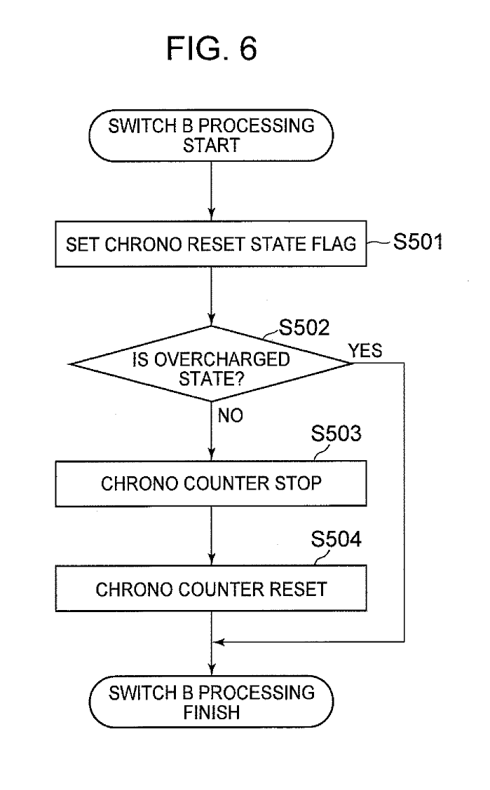

Next, the processing sequence of the switch B processing will be described. FIG. 6 is a flowchart that shows the processing sequence of the switch B processing in the present embodiment.

(Step S501) The processing unit 50 sets the value of the chrono state flag indicating the operation state of the chronograph to the “chrono reset state” indicating that the chronograph indicator is stopped at the “0” position. After that, the process proceeds to the processing of step S502.

(Step S502) The processing unit 50 determines whether or not the value of the charging state flag indicating the charging state of the electricity storage unit 13 is the “overcharged state” indicating the overcharged state. When the processing unit 50 determines that the value of the charging state flag is the “overcharged state”, the switch B processing is finished, and in other cases, the process proceeds to the processing of step S503.

(Step S503) The processing unit 50 stops the chrono counter. After that, the process proceeds to the processing of step S504.

(Step S504) The processing unit 50 sets the chrono counter value to “0” (reset). After that, the switch B processing is finished.

By executing the processings from step S501 to step S504 mentioned above, the electronic timepiece 1 is able to stop the time measurement operation using the chronograph and perform the reset.

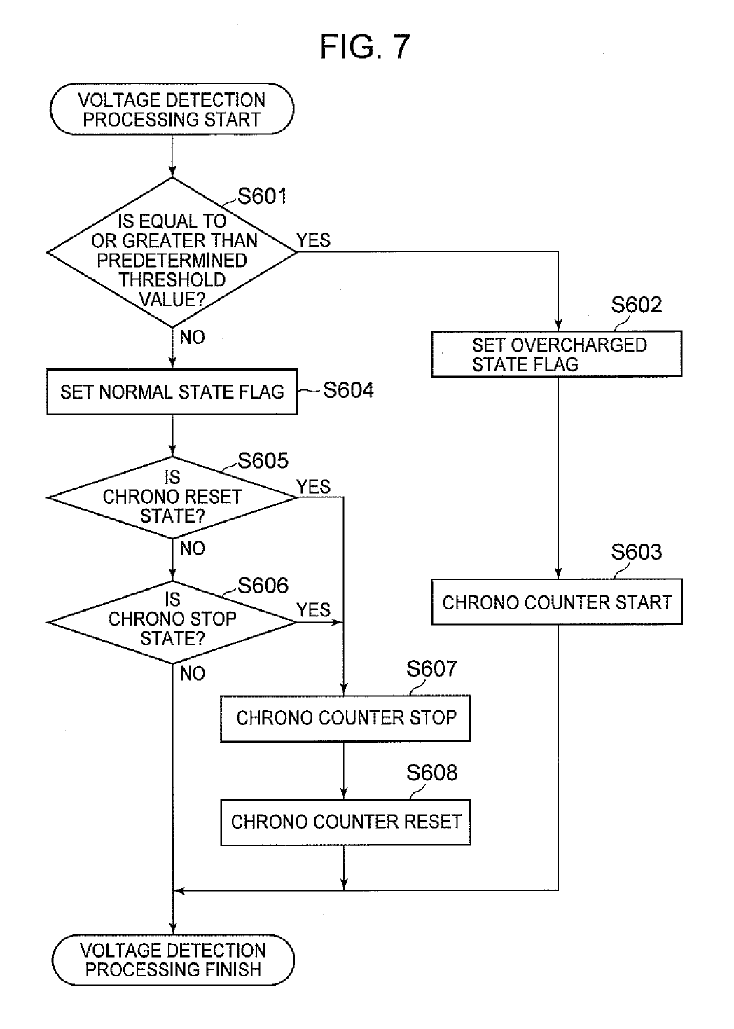

Next, the processing sequence of the voltage detection processing will be described. FIG. 7 is a flowchart that shows the processing sequence of the voltage detection processing in the present embodiment.

(Step S601) The processing unit 50 causes the voltage detection unit 40 to detect the output voltage value of the electricity storage unit 13. The voltage detection unit 40 detects the output voltage value of the electricity storage unit 13 and inputs the detection result to the processing unit 50. The processing unit 50 determines whether or not the output voltage value of the electricity storage unit 13 detected by the voltage detection unit 40 is equal to or greater than a predetermined threshold value. When the processing unit 50 determines that the output voltage value of the electricity storage unit 13 detected by the voltage detection unit 40 is equal to or greater than a predetermined threshold value, the process proceeds to the processing of step S602, and in other cases, the process proceeds to the processing of step S604.

In addition, the predetermined threshold value may be a value by which it is possible to determine whether or not the electricity storage unit 13 is in the overcharged state. For example, in the case of the electricity storage unit 13 which outputs the voltage of 1.5 V in the normal state, the predetermined threshold value is 2.5 V. In this case, if the output voltage value of the electricity storage unit 13 detected by the voltage detection unit 40 is equal to or greater than 2.5 V, the processing unit 50 determines that the electricity storage unit 13 is in the overcharged state. Furthermore, if the output voltage value of the electricity storage unit 13 detected by the voltage detection unit 40 is less than 2.5 V, the processing unit 50 determines that the storage unit 13 is the normal state.

(Step S602) The processing unit 50 sets the value of the charging state flag indicating the charging state of the electricity storage unit 13 to the “overcharged state” indicating the overcharged state. After that, the process proceeds to the processing of step S603.

(Step S603) The processing unit 50 starts the chrono counter. After that, the voltage detection processing is finished.

(Step S604) The processing unit 50 sets the value of the charging state flag indicating the charging state of the electricity storage unit 13 to the “normal state” indicating that the normal state (not the overcharged state). After that, the process proceeds to the processing of step S605.

(Step S605) The processing unit 50 determines whether or not the value of the chrono state flag indicating the operation state of the chronograph is the “chrono reset state” indicating that the chronograph indicator is stopped at the “0” position. When the processing unit 50 determines that the value of the chrono state flag is the “chrono reset state”, the process proceeds to the processing of step S607, and in other cases, the process proceeds to the processing of step S606.

(Step S606) The processing unit 50 determines whether or not the value of the chrono state flag indicating the operation state of the chronograph is the “chrono stop state” indicating that the chronograph indicator is stopped at the position other than “0”. When the processing unit 50 determines that the value of the chrono state flag is the “chrono stop state”, the process proceeds to the processing of step S607, and in other cases, the voltage detection processing is finished.

(Step S607) The processing unit 50 stops the chrono counter. After that, the process proceeds to the processing of step S608.

(Step S608) The processing unit 50 sets the chrono counter value to “0” (reset). After that, the voltage detection processing is finished.

By executing the processings from step S601 to step S608 mentioned above, the electronic timepiece 1 starts the chrono counter when the electricity storage unit 13 enters the overcharged state. As a result, the electric power stored in the electricity storage unit 13 is consumed by operating the second driving circuit 62 to output the driving pulse (the main driving pulse, and the correction driving pulse), whereby the overcharging can be prevented.

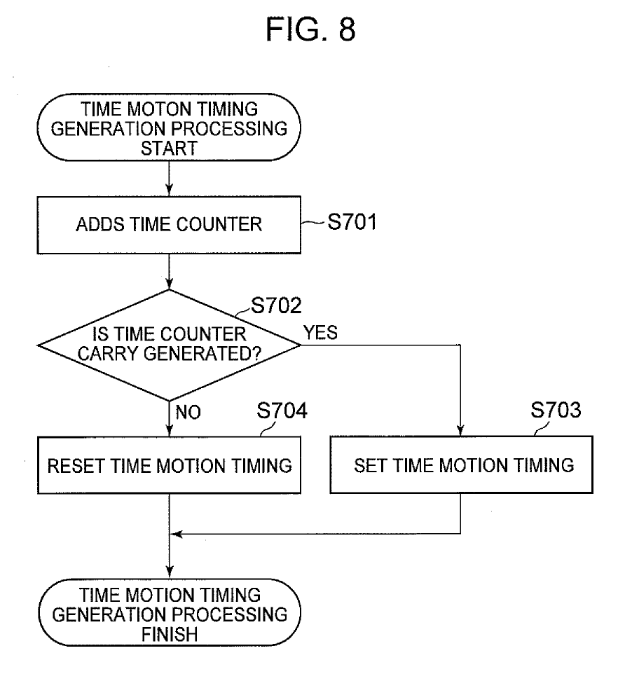

Next, the processing sequence of the time motion timing generation processing will be described. FIG. 8 is a flowchart that shows the processing sequence of the time motion timing generation processing in the present embodiment.

(Step S701) The processing unit 50 adds the time counter based on the standard clock signal which is input from the divider circuit 31. After that, the process proceeds to the processing of step S702.

(Step S702) When the value of the time counter is a value indicating the timing of moving the needle indicating the time (when the time counter carry is generated), the processing unit 50 proceeds to the processing of step S703, and in other cases, proceeds to the processing of step S704.

(Step S703) The processing unit 50 sets the value of the time motion timing flag indicating the timing of moving the needle indicating the time to the “set”. After that, the time motion timing generation processing is finished.

(Step S704) Since it is not the timing of moving the needle indicating the time, the processing unit 50 sets the value of the time motion timing flag to the “reset”. After that, the time motion timing generation processing is finished.

By executing the processings from step S701 to step S704 mentioned above, the electronic timepiece 1 is able to set the time motion timing flag.

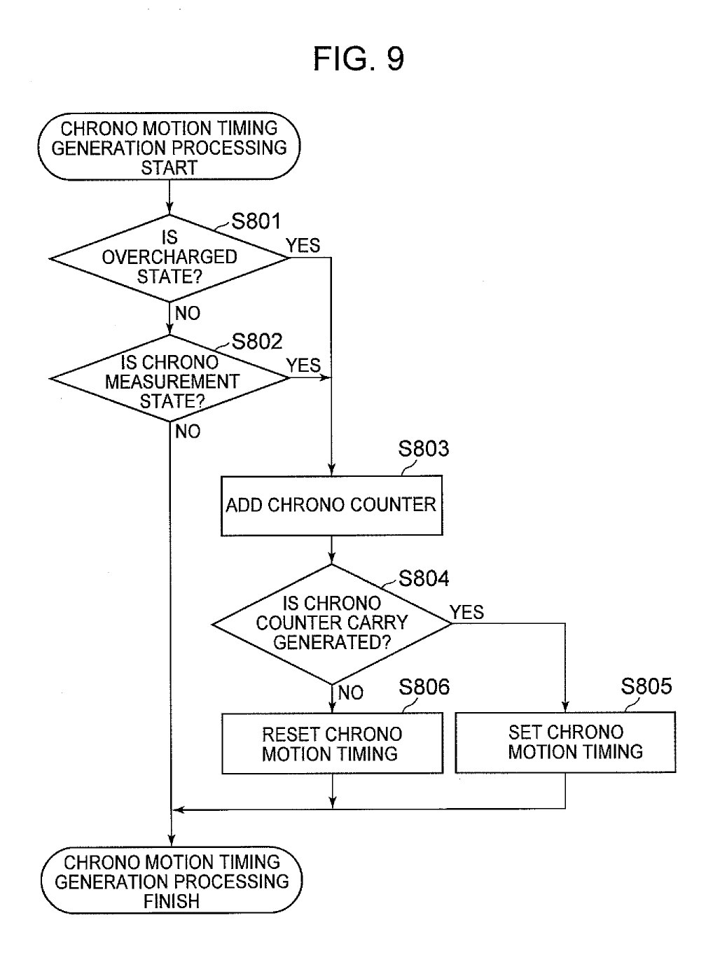

Next, the processing sequence of the chrono motion timing generation processing will be described. FIG. 9 is a flowchart that shows the processing sequence of the chrono motion timing generation processing in the present embodiment.

(Step S801) The processing unit 50 determines whether or not the value of charging state flag indicating the charging state of the electricity storage unit 13 is the “overcharged state” indicating the overcharged state. When the processing unit 50 determines that the value of the charging state flag is the “overcharged state”, the process proceeds to the processing of step S803, and in other cases, the process proceeds to the processing of step S802.

(Step S802) The processing unit 50 determines whether or not the value of the chrono state flag indicating the operation state of the chronograph is the “chrono measurement state” indicating the state of measuring the time. When the processing unit 50 determines that the value of the chrono state flag is the “chrono measurement state”, the process proceeds to the processing of step S803, and in other cases, the chrono motion timing generation processing is finished.

(Step S803) The processing unit 50 adds the chrono counter based on the standard clock signal which is input from the divider circuit 31. After that, the process proceeds to the processing of step S804.

(Step S804) When the value of the chrono counter is a value indicating the timing of moving the chronograph indicator (when the chrono counter carry is generated), the processing unit 50 proceeds to the processing of step S805, and in other cases, proceeds to the processing of step S806.

(Step S805) The processing unit 50 sets the value of the chrono motion timing flag indicating the timing of moving the chronograph indicator to the “set”. After that, the chrono motion timing generation processing is finished.

(Step S806) Since it is not the timing of moving the chronograph indicator, the processing unit 50 sets the value of the chrono motion timing flag to the “reset”. After that, the chrono motion timing generation processing is finished.

By executing the processings from step S801 to step S806 mentioned above, the electronic timepiece 1 is able to set the chrono motion timing flag.

As mentioned above, according to the present embodiment, the reset-to-zero structure of the chronograph of the electronic timepiece 1 depends on a mechanism, and thus, when the time measurement operation using the chronograph is not performed, the chronograph indicator is mechanically fixed. Furthermore, when the electricity storage unit 13 is in the overcharged state, even when not the time measurement operation using the chronograph, the processing unit 50 consumes the electric power stored in the electricity storage unit 13 by operating the second driving circuit 62 to output the driving pulse (the main driving pulse, the correction driving pulse), thereby preventing the overcharging. At this time, since the second driving circuit 62 outputs the driving pulse, the chrono display motor 64 tries to rotate. However, since the chronograph indicator is mechanically fixed, the chronograph indicator is not driven. Thus, the electronic timepiece 1 in the present embodiment is able to prevent overcharging without degrading the performance of the electricity storage unit 13 even in a case where the motion is stopped.

Furthermore, in a case of temporarily stopping the time measurement operation using the chronograph after being started, there is also a need to set the value of the chrono counter to the value when being temporarily stopped. However, in order to output the driving pulse by driving the second driving circuit 62 so as to prevent overcharging, there is a need to continuously move the chrono counter without being stopped. Thus, despite the time measurement operation using the chronograph is temporarily stopped, the values of the chrono counter are added. In the present embodiment, in order to prevent overcharging, before the second driving circuit 62 is operated to output the driving pulse, the chrono counter value when being temporarily stopped is temporarily memorized in the memory unit 71, and in a case of restarting the time measurement operation using the chronograph, the temporarily memorized value is used as the chrono counter value. Thus, even in a case of restarting the time measurement operation using the chronograph, the time measurement operation can be correctly restarted.

### Second Embodiment

Next, a second embodiment of the present invention will be described. The present embodiment is different from the first embodiment in the processing sequence of the chrono motor drive processing. The processings are the same as those of the first embodiment except for the configuration of the electronic timepiece 1 and the chrono motor drive processing.

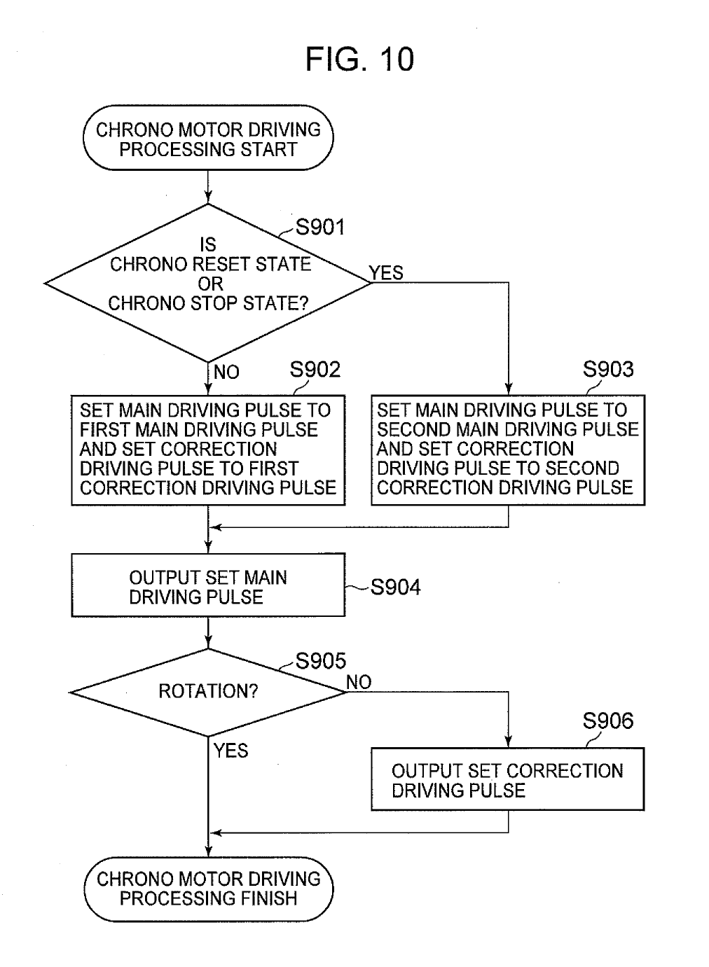

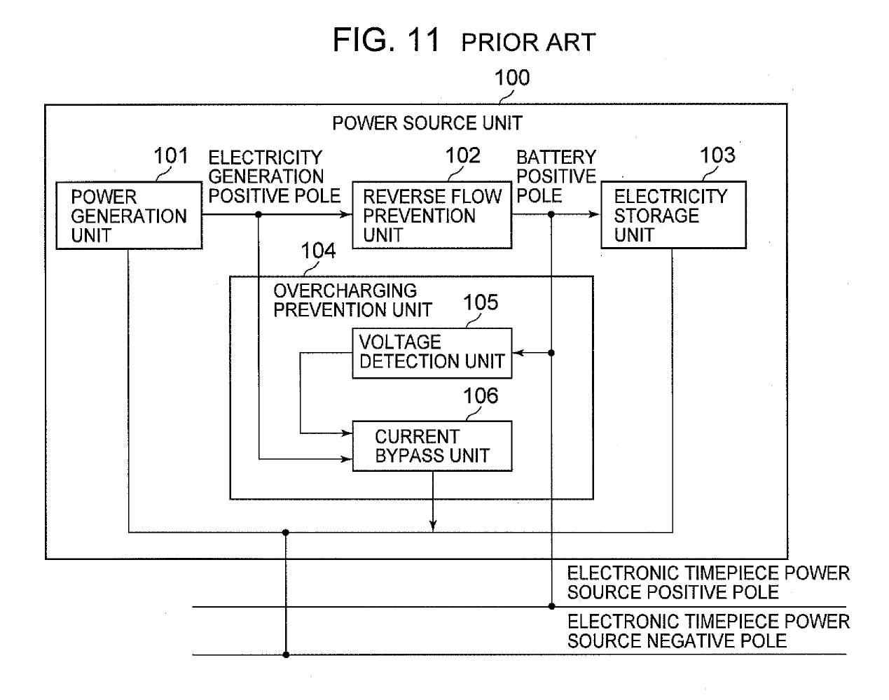

FIG. 10 is a flowchart that shows the processing sequence of the chrono motor drive processing in the present embodiment.

(Step S901) The processing unit 50 determines whether or not the value of the chrono state flag indicating the operation state of the chronograph is any one state of the “chrono reset state” indicating that the chronograph indicator is stopped at the “0” position, or the “chrono stop state” indicating that the chronograph indicator is stopped at a position other than “0”. When the processing unit 50 determines that the value of the chrono state flag is the “chrono reset state” or the “chrono stop state”, the process proceeds to the processing of step S903, and in other cases, the process proceeds to the processing of step S902.

(Step S902) The processing unit 50 sets the main driving pulse to a “first main driving pulse”, and sets the correction driving pulse to a “first correction driving pulse”. The first main driving pulse and the first correction driving pulse are called a first driving pulse. After that, the process proceeds to the processing of step S904. In addition, the first main driving pulse is a pulse having the same driving energy as that of the main driving pulse in the first embodiment. Furthermore, the first correction driving pulse is a pulse having the same driving energy as that of the correction driving pulse in the first embodiment.

(Step S903) The processing unit 50 sets the main driving pulse to a “second main driving pulse”, and sets the correction driving pulse to a “second correction driving pulse”. The second main driving pulse and the second correction driving pulse are called the second driving pulse. After that, the process proceeds to the processing of step S904. In addition, the second main driving pulse is a pulse having a driving energy higher than that of the first main driving pulse. That is, the electric power consumption when outputting the second main driving pulse is greater than the electric power consumption when outputting the first main driving pulse. In addition, the second main driving pulse may be any pulse having a driving energy higher than that of the first main driving pulse. In addition, the second correction driving pulse is a pulse having a driving energy higher than that of the first correction driving pulse. That is, the electric power consumption when outputting the second correction driving pulse is greater than the electric power consumption when outputting the first correction driving pulse. In addition, the second correction driving pulse may be any pulse having a driving energy higher than that of the first correction driving pulse.

(Step S904) The processing unit 50 controls the second driving circuit 62 to output the set main driving pulse to the chrono display motor 64. Specifically, in a case where the “first main driving pulse” is set as the main driving pulse, the processing unit 50 controls the second driving circuit 62 to output the first main driving pulse to the chrono display motor 64. Furthermore, in a case where the “second main driving pulse” is set as the main driving pulse, the processing unit 50 controls the second driving circuit 62 to output the second main driving pulse to the chrono display motor 64. The chrono display motor 64 is rotated based on the first main driving pulse or the second main driving pulse to drive the chronograph indicator. In addition, depending on the environmental conditions in which the chrono display motor 64 is placed, in some cases, the chrono display motor 64 cannot be rotated in the main driving pulse, and the chrono graph needle cannot be driven. After that, the process proceeds to the processing of step S905.

(Step S905) The processing unit 50 determines whether or not the chrono display motor 64 is rotated in the processing of step S904. When the processing unit 50 determines that the chrono display motor 64 is rotated in the processing of step S904, the chrono motor drive processing is finished. When the processing unit 50 determines that the chrono display motor 64 is not rotated in the processing of step S904, the process proceeds to the processing of step S906.

(Step S906) The processing unit 50 controls the second driving circuit 62 to output the set correction driving pulse to the chrono display motor 64. Specifically, in a case where the “first correction driving pulse” is set as the correction driving pulse, the processing unit 50 controls the second driving circuit 62 to output the first correction driving pulse to the chrono display motor 64. Furthermore, in a case where the “second correction driving pulse” is set as the correction driving pulse, the processing unit 50 controls the second driving circuit 62 to output the second correction driving pulse to the chrono display motor 64. The chrono display motor 64 is rotated based on the first correction driving pulse or the second correction driving pulse to drive the chronograph indicator. After that, the chrono motor drive processing is finished.

As mentioned above, by executing the processings from step S901 to S906 mentioned above, in a case where the fixing of the chronograph minute hand, the chronograph second hand and the chronograph 1/10 second hand is released, the electronic timepiece 1 is able to drive the chronograph indicator based on the first main driving pulse or the first correction driving pulse. Furthermore, by executing the processings from step S901 to S906 mentioned above, in a case where the chronograph minute hand, the chronograph secondhand and the chronograph 1/10 second hand are fixed, the electronic timepiece 1 is able to output the second main driving pulse having a driving energy higher than that of the first main driving pulse and the second correction driving pulse having a driving energy higher than that of the first correction driving pulse without driving the chronograph needle.

As mentioned above, according to the present embodiment, the reset-to-zero structure of the chronograph of the electronic timepiece 1 depends on a mechanism, and in a case where the time measurement operation using the chronograph is not performed, the chronograph indicator is mechanically fixed. Furthermore, in a case where the time measurement operation using the chronograph is not performed, the processing unit 50 sets the main driving pulse and the correction driving pulse to the “second main driving pulse” and the “second correction driving pulse” that are the driving pulses having the higher driving energy. Moreover, when the electricity storage unit 13 is in the overcharged state, even in a case where the time measurement operation using the chronograph is not performed, the processing unit 50 consumes the electric power stored in the electricity storage unit 13 by operating the second driving circuit 62 to output the second main driving pulse and the second correction driving pulse, thereby preventing the overcharging. At this time, since the second driving circuit 62 outputs the second main driving pulse and the second correction driving pulse which are the pulses having the higher driving energy, the chronograph display motor 64 attempts to rotate. However, since the chronograph indicator is mechanically fixed, the chronograph indicator is not driven. Thus, the electronic timepiece 1 in the present embodiment is able to prevent overcharging without degrading the performance of the electricity storage unit 13 even in the case where the motion is stopped.

In addition, all or a part of the functions of each unit included in the electronic timepiece 1 mentioned above may be realized by recording the program for realizing the functions in a computer-readable recording medium and causing a computer system to read the program recorded on the recording medium and execute the program. In addition, the “computer system” mentioned herein includes an OS and hardware such as peripheral equipment.

Furthermore, the “computer-readable recording medium” refers to a portable medium such as a flexible disk, an optical magnetic disc, a ROM, and a CD-ROM, and a memory unit such as a hard disk built into the computer system. Furthermore, the “computer-readable recording medium” may include a medium which dynamically holds the program for a short time, such as a communication line in a case of transmitting the program via a network such as the Internet and a communication line such as a telephone line, and a medium which holds the program for a fixed time, such as a volatile memory included in the computer system which is the server or client of the above case. Furthermore, the program may realize a part of the functions mentioned above, or may realize the functions mentioned above in a combination with a program which is recorded in the computer system in advance.

As mentioned above, the first embodiment and the second embodiment of the present invention have been described, but the present invention is able to make various changes within the scope not departing from the gist of the present invention without being limited to the embodiment mentioned above. For example, in the embodiment mentioned above, the electronic timepiece 1 was the chronograph which includes the chronograph minute hand, the chronograph second hand and the chronograph 1/10 second hand. However, a chronograph indicator may be included which is different from the embodiment mentioned above, without being limited thereto.

What is claimed is:

1. An electronic timepiece which is a chronograph including a reset-to-zero structure using a mechanism, comprising:
a power generation unit which generates electric power depending on light to be irradiated to a light receiving surface;
an electricity storage unit which stores the electric power generated by the power generation unit and outputs the stored electric power;
a voltage detection unit which detects a voltage of the electric power that is output from the electricity storage unit;
a time measurement unit which performs time measurement;
a chronograph indicator which points a time counted by the time measurement unit and is fixed by the mechanism while the time measurement is stopped;
a driving circuit which drives the chronograph indicator by the use of the electric power that is output from the electricity storage unit; and
a control unit which drives the driving circuit when the voltage of the electric power which is output from the electricity storage unit is equal to or greater than a predetermined threshold value.

2. The electronic timepiece according to claim 1,
wherein the driving circuit outputs a first driving pulse by the use of the electric power which is output from the electricity storage unit and drives the chronograph indicator, and,
when the voltage of the electric power which is output from the electricity storage unit is equal to or greater than the predetermined threshold value while the time measurement is stopped, the control unit controls the driving circuit to output a second driving pulse having a driving energy greater than that of the first driving pulse.

3. The electronic timepiece according to claim 1,
wherein the time measurement unit performs the time measurement using a counter which adds values for each fixed time,
the driving circuit drives the chronograph indicator whenever the counter value increases by a fixed value, and the control unit operates the counter to drive the driving circuit, when the voltage of the electric power which is output from the electricity storage unit is equal to or greater than the predetermined threshold value.

4. The electronic timepiece according to claim 2,
wherein the time measurement unit performs the time measurement using a counter which adds values for each fixed time,
the driving circuit drives the chronograph indicator whenever the counter value increases by a fixed value, and
the control unit operates the counter to drive the driving circuit, when the voltage of the electric power which is output from the electricity storage unit is equal to or greater than the predetermined threshold value.

5. The electronic timepiece according to claim 3,
wherein the time measurement unit starts the time measurement after resetting the counter value, in a case of starting the time measurement when the counter is operated.

6. The electronic timepiece according to claim 4,
wherein the time measurement unit starts the time measurement after resetting the counter value, in a case of starting the time measurement when the counter is operated.

7. The electronic timepiece according to claim 3, further comprising:
a memory unit which memorizes a value used for the time measurement unit,
wherein the time measurement unit memorizes the counter value in the memory unit when temporarily stopping the time measurement, and restarts the time measurement by the use of the counter value memorized in the memory unit when restarting the temporarily stopped time measurement.

8. The electronic timepiece according to claim 4, further comprising:
a memory unit which memorizes a value used for the time measurement unit,
wherein the time measurement unit memorizes the counter value in the memory unit when temporarily stopping the time measurement, and restarts the time measurement by the use of the counter value memorized in the memory unit when restarting the temporarily stopped time measurement.

9. The electronic timepiece according to claim 5, further comprising:
a memory unit which memorizes a value used for the time measurement unit,
wherein the time measurement unit memorizes the counter value in the memory unit when temporarily stopping the time measurement, and restarts the time measurement by the use of the counter value memorized in the memory unit when restarting the temporarily stopped time measurement.

10. The electronic timepiece according to claim 6, further comprising:
a memory unit which memorizes a value used for the time measurement unit,
wherein the time measurement unit memorizes the counter value in the memory unit when temporarily stopping the time measurement, and restarts the time measurement by the use of the counter value-memorized in the memory unit when restarting the temporarily stopped time measurement.
